(19) United States
(12) Patent Application Publication
(10) Pub. No.: US 2001/0049294 A1
(43) Pub. Date: Dec. 6, 2001

(54) WRIST-WORN RADIOTELEPHONE ARRANGEMENT

(75) Inventor: FRED OLSEN, OSLO (NO)

Correspondence Address: ARTHUR G SCHAIER, CARMODY & TORRANCE LLP, P O BOX 1110, 50 LEAVENWORTH STREET, WATERBURY, CT, 067211110

(73) Assignee: Timex Corporation

(21) Appl. No.: 09/412,657

(22) Filed: Oct. 5, 1999

(51) Int. Cl. H04M 1/00

(52) U.S. Cl. 455/556; 455/557; 455/66

(57) ABSTRACT

A radiotelephone arrangement includes a wristworn device comprising a transceiver for receiving signals from and for transmitting signals to a wireless communications system and a controller coupled to the transceiver for controlling the transmission and reception of the signals. The battery for the wristworn device is coupled to the controller but is physically separated from the wristworn device during operation. Wires are preferably used to electrically connect the battery to the wristworn device. Alternatively, the radiotelephone arrangement comprises a wristworn unit and a radiotelephone unit. Local transceivers in each unit permits the wristworn unit to control the radiotelephone unit remotely.

### BACKGROUND OF THE INVENTION

The present invention relates generally to radiotelephones, and in particular, to an improved radiotelephone arrangement that can advantageously be incorporated into a wristworn device.

The circuitry, network switching equipment and techniques for linking radiotelephones to communication networks are highly sophisticated. Also, miniaturization of radiotelephones and their components have become a high priority. Still further, with the miniaturization of such components now being sufficiently obtained, radiotelephones, including cellular phones that can be worn on the wrist, are becoming increasing popular. The Assignee of the present invention recognized the need for advanced technology and miniaturization in the radiotelephone art many years ago, one aspect of which is described in U.S. Pat. No. 4,847,818, assigned to the present assignee and incorporated by reference as if fully set forth herein.

Currently, several companies are working on improvements in radiotelephone technology including cellular telephone technology that can be worn on the wrist.

Still however, one of the most undesirable drawbacks with wristworn devices, such as radiotelephones, is their size, and one of the biggest contributors to the size of wristworn devices is the battery. As such, many efforts have been made to reduce the size thereof.

For example, U.S. Pat. Nos. 3,973,706 (Boyce et al.), 4,194,355 (Nishida), 4,427,303 (Matthias) and 4,586,827 (Hirsh et al.) all describe ways to reduce the size of wristworn devices, such as watches. However, it has become clear that such constructions are still less than acceptable for such wristworn radiotelephones, as a battery small enough to fit on the watch strap of such a device may have an undesirably short battery life.

Still further, the prior art radiotelephone constructions do not satisfactorily overcome the problems associated with poor reception and transmission performance due to the inadequate antenna characteristics that are dictated by the miniaturization of the radiotelephone, and may even have less than adequate acoustic characteristics due to the small microphones and speakers required to fit into the radiotelephone device.

Accordingly it is desirable to provide a radiotelephone arrangement, such as a wristworn cellular telephone, that overcomes the aforementioned drawbacks and achieves the aforementioned and below mentioned objectives. In particular, it is desirable to provide a radiotelephone arrangement that permits the heretofore unappreciated physical battery separation from the wristworn radiotelephone device.

Additionally, it is desirable to provide a wristworn device, such as a timepiece, for example, a watch or a pager watch, that can communicate with a portable radiotelephone, such as a cellular phone. That is, currently portable cellular phones, for example, are very popular. However, quick access to the phone is not always achievable if for example, the phone is in a briefcase or a purse, or in a pocket or otherwise out of one's immediate reach. Communication and/or control of the portable cellular phone with a wristworn device, such as a watch, would be advantageous and desirable. The present invention achieves the aforementioned advantages as well.

### SUMMARY OF THE INVENTION

Generally speaking, in accordance with the present invention, a radiotelephone arrangement is provided. In a first preferred embodiment, the arrangement includes a wristworn device that may comprise a transceiver for receiving signals from and for transmitting signals to a wireless communications system and a controller coupled to the transceiver for controlling the transmission and reception of the signals. Importantly, the battery for the wristworn device is coupled to the controller but is physically separated from or otherwise indirectly coupled to the wristworn device during operation. For example, the battery could be placed in a pocket of the user, worn around the neck or secured to the waist or belt of the user. Wires are preferably used to electrically connect the battery to the wristworn device.

In a second embodiment of the present invention, a radiotelephone arrangement comprising a wristworn unit and a radiotelephone unit is provided. In the preferred construction, the wristworn unit comprises a transceiver for communicating with the radiotelephone unit and a controller for controlling the transceiver and the transmission of and reception of intra-unit signals to and from the radiotelephone unit. The radiotelephone unit comprises a first transceiver for receiving signals from and transmitting signals to a wireless communications system, a controller coupled to the radiotelephone unit transceiver for controlling the transmission and reception of the signals, and a second transceiver coupled to the radiotelephone unit controller for transmitting to and receiving the intra-unit signals from the wristworn unit transceiver. In this way, the wristworn unit can effectively control the radiotelephone unit as further disclosed herein.

Accordingly, it is an object of the present invention to provide an improved radiotelephone arrangement that can be worn on a wrist.

Yet another object of the present invention is to provide an improved wristworn radiotelephone arrangement that can be incorporated into a wristwatch.

Still another object of the present invention is to provide an improved wristworn radiotelephone arrangement that is ascetically pleasing to a user.

Another object of the present invention is to provide an improved wristworn radiotelephone arrangement that can be used in combination with a battery having at least competitively commensurate battery life as normal hand-held cellular telephone batteries.

And yet another object of the present invention is to provide an improved wristworn radiotelephone arrangement that reduces the undesirable effects of the dissipation of heat from use.

And still another object of the present invention is to provide an improved wristworn radiotelephone arrangement that provides for the optimization of antenna and acoustic performance.

And yet another object of the present invention is to provide a wristworn device, such as a watch, that can communicate and/or control a portable radiotelephone, such as a portable cellular telephone.

Lastly, it should be recognized that the reference to radiotelephones should be understood to mean a broad range of wireless communication devices, such as cordless phones or point-to-point devices, and may likewise be incorporated with timekeeping technology, such as that found in a wristwatch.

Still other objects and advantages of the invention will in part be obvious and will in part be apparent from the specification.

The invention accordingly comprises the features of construction, combination of elements and arrangement of parts which will be exemplified in the construction hereinafter set forth, and the scope of the invention will be indicated in the claims.

### BRIEF DESCRIPTION OF THE DRAWINGS

FIG. 1 is combination block diagram of a wristworn radiotelephone arrangement constructed in accordance with a first embodiment of the present invention and a simplified illustration of a radiotelephone communication system to which the present invention may be bidirectionally coupled through wireless RF links;

FIGS. 2A-2D are exemplary configurations illustrating the use of the present invention; and

FIG. 3 is block diagram of a wristworn device and radiotelephone unit constructed in accordance with a second embodiment of the present invention.

### DETAILED DESCRIPTION OF THE PREFERRED EMBODIMENTS

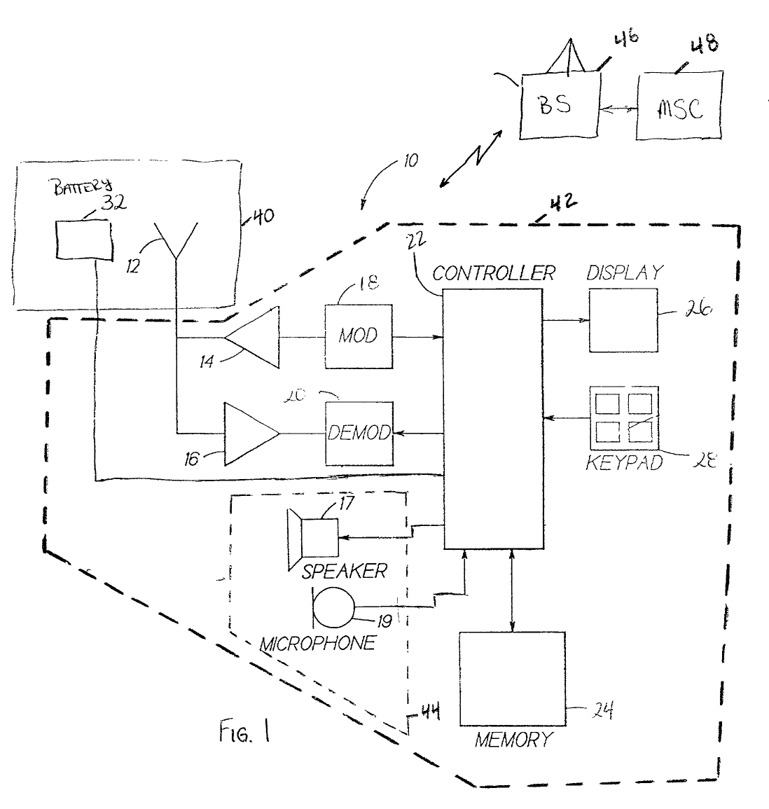

Reference is made to FIG. 1 for illustrating a wireless user terminal or wristworn radiotelephone 10, such as but not limited to a cellular radiotelephone or a personal communicator, that is suitable for practicing the present invention.

In the preferred embodiment, radiotelephone arrangement 10 is uniquely separated into at least two physically separated and electrically coupled components, and specifically, a wristworn unit 42 and a battery assembly 40. It should be understood, as further discussed below, that a separate headset assembly 44 may also be provided, although the separation of headset assembly 44 from wristworn unit 42 is not material to the present invention.

As also illustrated in FIG. 1 and generally disclosed herein as the details should be well understood by one of skill in the art, radiotelephone arrangement 10 can interface with a base station 46 which itself is bidirectionally connected to a mobile switching center 48. Base station 46 provides the necessary connections when the radiotelephone arrangement 10 is involved in a call.

The radiotelephone arrangement 10, and the wristworn unit 42 in particular, preferably includes a modulator 18, a transmitter 14 and a receiver 16 (e.g. a transceiver) for respectively transmitting information (i.e. signals) to and receiving information from a control channel of the communications system in which it is operating, a demodulator 20, and a controller 22 that provides signals to and receives signals from the transmitter 14 and receiver 16, respectively. These signals include signaling information in accordance with the air interface standard of the applicable cellular system, and also user speech and/or user generated data. The air interface standard is assumed for this invention to include a physical and logical frame structure of a type such as TIA/EIA/IS-91, and any other similar or related air interface standards. It should be understood that the radiotelephone arrangement 10 can be capable of operating with one or more air interface standards, modulation types, and access types. By example, the radiotelephone arrangement 10 may be capable of operating with any of a number of other standards besides IS-91, such as GSM and IS-95 (CDMA). Narrow-band AMPS (NAMPS), as well as TACS radiotelephones, may also benefit from the teaching of this invention, as should dual or higher mode phones (e.g., digital/analog or TDMA/CDMA/analog phones). It should thus be clear that the teaching of this invention is not to be construed to be limited to any one particular type of radiotelephone arrangement or air interface standard.

It is understood that the controller 22 controls the transmission and reception of the information (i.e. signals) being transmitted from and to radiotelephone arrangement 10 and preferably also includes the circuitry required for implementing the audio and logic functions of radiotelephone arrangement 10. By example, the controller 22 may be comprised of a digital signal processor (DSP) device, a microprocessor device, various analog to digital converters, digital to analog converters, and other support circuits. The control and signal processing functions of the wristworn unit 42 are allocated between these devices according to their respective capabilities.

It should be realized that in other embodiments, the radiotelephone arrangement 10 may function as a data terminal for at least one of transmitting or receiving packet data. The radiotelephone arrangement 10 which functions as a data terminal can include a data port (not shown) which is coupled to the controller 22.

The radiotelephone arrangement 10 also includes various memories, shown collectively as the memory 24, wherein are stored a plurality of constants and variables that are used by the controller 22 during the operation of radiotelephone arrangement 10. For example, the memory 24 may store the values of various cellular system parameters and the number assignment module (NAM), the operating program for controlling the operation of controller 22, packet data prior to transmission or after reception, and operating programs including instructions for implementing the applicable air interface standard.

A user interface preferably includes a display 26, and a user input device, typically a keypad 28, all of which are coupled to the controller 22 in a known manner. Keys may be provided such as a SEND key, various menu scrolling and soft keys, and a PWR key, all of which is well known in the art.

As stated above, headset assembly 44 may also be, but not required to be, physically separated from wristworn unit 42. In the preferred embodiment, assembly 44 may be easily worn about the head in a manner well known in the art and discussed below.

In accordance with the present invention, provided in assembly 40 is a battery 32 and preferably an antenna 12. As antenna 12 transmits signals to and receives signals from the transceiver within wristworn unit 42 in a known manner, it is preferable that it too be separated from unit 42 to provide for the best transmission and reception. However, antenna 12 may be incorporated within wristworn unit 42. With at least battery 32 within assembly 40, assembly 40 is then physically separated from (or otherwise indirectly coupled to) wristworn unit 40 so as to achieve the objectives set forth herein. Battery 32 is preferably rechargeable and can use a variety of chemical technologies to store electrical energy, as is well known in the art.

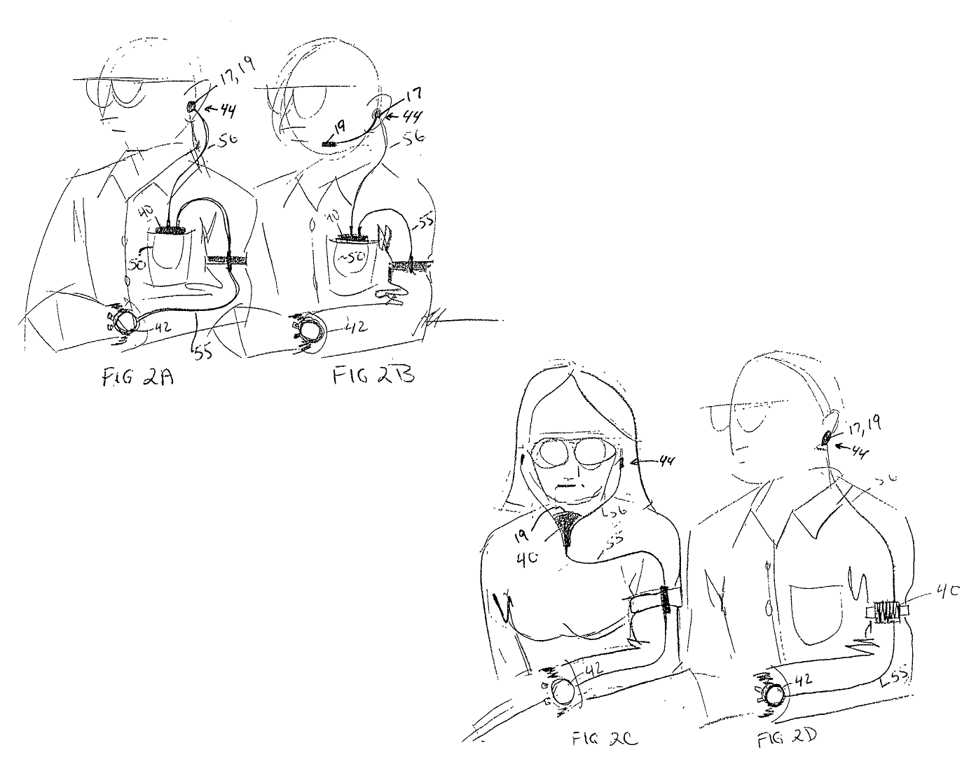

As may now be appreciated and with particular reference to FIGS. 2A-2D, the present invention improves the prior art wristworn radiotelephone technology by physically separating at least battery 32 from the remaining wristworn electronics in a way that permits a more reasonably sized and ascetically pleasing wristworn unit 42.

For example, assembly 40 may be put in a breast pocket 50 of the user (FIGS. 2A, 2B), hung around a neck from a chain or headset of the user (FIG. 2C), or even secured to a sleeve (FIG. 2D), belt or waist (not shown) of the user. Having antenna 12 disposed in assembly 40 permits increased reception capability, as an antenna contained solely within wristworn unit 42 may be undesirably unreliable in reception and/or transmission in a manner discussed above.

FIGS. 2A, 2B, 2C and 2D also illustrate embodiments having physically separated headset assemblies 44, with FIGS. 2A and 2D illustrating technically sophisticated combination earpiece and microphones, while FIG. 2B shows a more conventional headset arrangement including separate microphone 19 and speaker 17 components. FIG. 2C shows a contemplated construction wherein the microphone 19 may be located in assembly 40. Again, the important feature of the present invention is the physical separation of battery 32 from wristworn unit 42.

The battery of a radiotelephone, such as a cellular telephone, is one of the largest elements thereof. As such, much consideration goes into its placement within the cellular telephone as well as its size, as these factors directly impact the available talk and standby time. By physically separating at least battery 32 from wristworn unit 42, the present invention advantageously minimizes the size of wristworn unit 42. Moreover, as stated above, removing the battery 32 from the wristworn unit 42 as disclosed herein provides significant and numerous advantages, as discussed above, such as a minimally sized wristworn unit with long standby and talktime capabilities.

In this first embodiment, and as schematically illustrated in FIG. 1 and depicted in FIGS. 2A-2D, a wire 55 electrically couples the wristworn unit 42 to assembly 40, and in particular, of battery 32 to controller 22 and antenna 12 to the receiver 16 and transmitter 14. A separate wire 56 electrically couples headset assembly 44 to wristworn unit 42 through assembly 40. That is, wire 56 may be connected in a known manner into assembly 40 to facilitate the necessary electrical coupling of headset assembly 44 to wristworn unit 42. That is, assembly 40 preferably contains input and output connectors (not shown) to permit the insertion of wires 55 and 56 into assembly 40 in a well known manner. Likewise, wristworn unit 42 preferably includes an input to receive wire 55 thereby electrically coupling assembly 40 and headset assembly 44 to wristworn unit 42.

As can now be appreciated, by utilizing the present invention and physically removing the battery from the wristworn cell phone electronics, which preferably includes such components as the display and the dialing device, the present invention enables those skilled in the art to produce improved wristworn radiotelephone arrangements as well as wristwatches with improved telephone functionality. Still further, by separating the microphone and speaker from the wristworn unit, the size of the radiotelephone can still be further minimized while improving reception and communication.

Yet further, the present invention contemplates the further separation of components whereby additional components, disclosed above to be within wristworn unit 42, are relocated into assembly 40. The following examples are provided by way of example and not limitation. That is for example, the circuitry such as modulator 18, demodulator 20, transmitter 14, receiver 16 and/or controller 22 may be disposed within assembly 40. In this way, many of the components that consume the majority of the power could be located in assembly 40. Such a construction would reduces the demands on the wiring disclosed in FIGS. 2A-2D. Additionally, the separation of the transmitter from the wristworn unit 42 also advantageously results in the elimination of irritation caused by the heat dissipation of the transmitter that could otherwise irritate the wearer's wrist. Constructed in this manner, wristworn unit 42 could be yet further reduced in size.

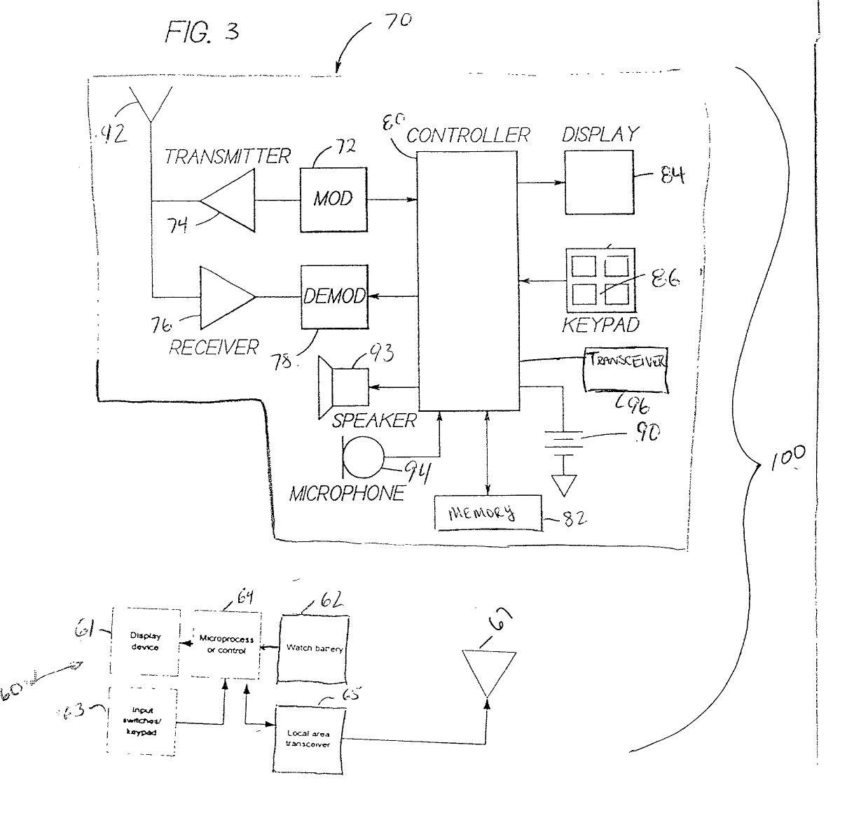

Reference is made to FIG. 3 for illustrating a second embodiment of the present invention, and in particular an arrangement 100 that includes a combination wristworn unit 60, such as a device including timekeeping functions, such as a watch, and a radiotelephone unit 70, such as but not limited to a cellular radiotelephone or a personal communicator.

It should be understood that radiotelephone unit 70 is intended to communicate with a base station (not shown) in the same manner as radiotelephone arrangement 10 and may have the same operating features and functionality (such as operating as a data terminal) as radiotelephone arrangement 10, and therefore, details therefor shall not be repeated.

As with radiotelephone arrangement 10, radiotelephone unit 70 preferably includes a modulator 72, a transmitter 74 and a receiver 76 similar in function to transmitter 14 and receiver 16, respectively, a demodulator 78, and a controller 80 that includes (at least) all the functionality and circuitry of controller 22. Likewise, radiotelephone unit 70 may also include various memories (collectively memory 82) in a manner and construction similar to memory 24.

Radiotelephone unit 70 may also include a display 84 and keypad 86 similar to the corresponding components and features of wristworn unit 42.

In this second embodiment, a battery 90 and antenna 92 are preferably included in radiotelephone arrangement 70 in a known manner, such as that described in U.S. Pat. No. 5,819,174 and well known in the art. Also included in a known manner in radiotelephone unit 70 is a speaker 93 and microphone 94.

In accordance with the present invention, radiotelephone unit 70 may be used in together with wristworn unit 60, which by example may be a wristwatch, having timekeeping functionality and control circuiting such as that described in U.S. Pat. No. 5,555,226, assigned to the present assignee and incorporated by reference as if fully set forth herein. In particular, wristworn unit 60 preferably includes a display device 61 for displaying information and may for example, be a vacuum fluorescent, LED or LCD device. A battery 62 and user interface 63 which may be pushbuttons or the like, is preferably included as would be appreciated by one skilled in the art and described in sufficient detail for purposes of background information in the aforementioned '226 patent. A microcontroller 64, which at least controls the operation of wristworn unit 60 in a manner described in the '226 patent and well known to one skilled in the art, is also provided.

As stated above, an objective of the present invention is to provide a wristworn device, such as a watch, that can interface and otherwise communicate with, a radiotelephone unit, such as a cellular phone. In this way, the cellular phone may be kept in a pocket or otherwise out of view or reach so as not to interfere with, or inhibit the movements of a user, while permitting the user to use the wristworn unit to, for example, see the phone numbers of a party calling, to dial a third party using dialing functionality in the wristworn unit 60 and otherwise generally use the display of the wristworn unit 60 in lieu of the display of the radiotelephone display while the radiotelephone unit 70 is not readily accessible to the user. That is, in accordance with the present invention, it is an object to provide a communication link between wristworn unit 60 and radiotelephone unit 70.

In accordance therewith, radiotelephone unit 70 includes a local area bi-directional transceiver 96 operatively coupled to controller 80. In a similar manner, wristworn unit 60 includes a local area bi-directional transceiver 65 operatively coupled to controller 64.

By adding a bi-directional transceiver 96 to radiotelephone unit 70 and a corresponding bi-directional transceiver 65 to wristworn unit 60, wristworn unit 60 can effectively control the radiotelephone unit 70. In particular, controller 64 of wristworn unit 60 includes the operatively circuitry, programming and other functionality, as would be understood by one skilled in the art, for controlling and interfacing with radiotelephone unit 70, and transceiver 96 in particular. That is, controller 64 would include the necessary programming, connectivity and interfacing circuitry to accept and send data to transceiver 96 thereby providing control of radiotelephone unit 70 from wristworn unit 60. That is, transceiver 65 would be used to transmit and receive control signals via an antenna 67 to and from transceiver 96.

Controller 80 likewise contains the functionality, circuitry and programming sufficient to achieve effective communication with the base station and wristworn unit 60. In particular, controller 80 would interface with transceiver 96 in a manner that would provide for communication with tranceiver 65 of wristworn unit 60.

For example, the transceiver frequency and modulation methods would be selected on the basis of required range, data rates, cost and regulatory requirements as all would be understood by one of ordinary skill in the art. In this way, each of the transceivers 65 and 96 would incorporate the appropriate control elements to enable effective communication of the radiotelephone unit 70 by the wristworn unit 60. It should also be understood that radiotelephone unit 70 could operate independently of wristworn unit 60 as is done in the aforementioned '174 patent.

By physically separating the battery from the wristworn unit as disclosed herein, the present invention achieves all of the aforementioned advantages disclosed above, including the ability to provide an improved wristworn radiotelephone arrangement that can be incorporated into a wristwatch, is ascetically pleasing to a user, that can be used in combination with a battery having at least competitively commensurate battery life as normal hand-held cellular telephone batteries, that reduces the undesirable effects of the dissipation of heat from use, and that provides for the optimization of antenna and acoustic performance. For example, by using wires, such as those disclosed herein from the wristworn unit to the battery assembly, reception and transmission (i.e. antenna) communication performance may be enhanced. Additionally, using a physically separated headset assembly as disclosed herein may enhance acoustic quality.

Moreover, by utilizing the present invention, control of a radiotelephone by a wristworn unit, such as a watch, is effectively accomplished. Such a construction provides the advantages heretofore identified.

It will thus be seen that the objects set forth above, among those made apparent from the preceding description, are efficiently attained and, since certain changes may be made in the above constructions without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention described herein and all statements of the scope of the invention which as a matter of language might fall therebetween.

I claim:

1. A radiotelephone arrangement comprising:
a wristworn device, the wristworn device comprising a transceiver for one of receiving a signal from and for transmitting a signal to a wireless communications system; and a controller coupled to the transceiver for controlling the transmission and reception of the respective signals;
a battery coupled to the controller for powering the radiotelephone arrangement, the battery being physically separated from the wristworn device when the radiotelephone arrangement is at least one of transmitting the signal to and receiving the signal;
a connector for electrically connecting the battery to the wristworn device.

2. The radiotelephone arrangement as claimed in claim 1, wherein the wristworn device includes a display for displaying information and a user interface for providing input signals to the controller.

3. The radiotelephone arrangement as claimed in claim 1, including a battery assembly that includes the battery, wherein the battery assembly further includes an antenna for transmitting the signal to and receiving the signal from the communications system.

4. The radiotelephone arrangement as claimed in claim 1, wherein the connection is comprised of a wire electrically coupling the battery to the controller of the wristworn unit.

5. The radiotelephone arrangement as claimed in claim 1, including a headset assembly comprising a microphone and a speaker, and means for electrically coupling the microphone and the speaker to the controller.

6. A radiotelephone arrangement comprising:
a wristworn device and a battery assembly, wherein one of the wristworn device and the battery assembly comprises a transceiver for one of receiving a signal from and for transmitting a signal to a wireless communications system and a controller coupled to the transceiver for controlling the transmission and reception of the respective signals; and
wherein the battery assembly comprises at least a battery, coupled to the controller and the wristworn device, for powering the radiotelephone arrangement;
the battery being physically separated from the wristworn device when the radiotelephone arrangement is at least one of transmitting the signal to and receiving the signal;
a connector for electrically connecting the battery to the wristworn device.

7. A radiotelephone arrangement comprising: a wristworn unit and a radiotelephone unit, wherein
the wristworn unit comprises a wristworn unit transceiver for communicating with the radiotelephone unit, a wristworn unit controller for controlling the wristworn unit transceiver and the transmission of intra-unit signals to and reception of intra-unit signals from the radiotelephone unit; and wherein
the radiotelephone unit comprises a first radiotelephone unit transceiver for one of receiving signals from and transmitting signals to a wireless communications system; a radiotelephone unit controller coupled to the first radiotelephone unit transceiver for controlling the transmission and reception of the signals; and a second radiotelephone unit transceiver coupled to the radiotelephone unit controller for transmitting to and receiving the intra-unit signals from the wristworn unit transceiver.

8. The radiotelephone arrangement as claimed in claim 7, wherein the wristworn unit includes a display for exhibiting information contained in the signals.

9. The radiotelephone arrangement as claimed in claim 7, wherein the wristworn unit includes a user interface coupled to the wristworn unit controller, and wherein the radiotelephone unit controller is controllable from the user interface.
